(19) United States
(12) Patent Application Publication
(10) Pub. No.: US 2009/0273600 A1
(43) Pub. Date: Nov. 5, 2009

(54) DESIGN SUPPORTING APPARATUS AND DESIGN SUPPORTING METHOD

(75) Inventor: Yukari Satou, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/395,704

(22) Filed: Mar. 1, 2009

(30) Foreign Application Priority Data
Feb. 28, 2008 (JP) 2008-048459

(51) Int. Cl. G06T 15/00

(52) U.S. Cl. 345/419

(57) ABSTRACT

A design supporting apparatus calculates, based on flexible object model data as data concerning a flexible object fixed at least at two points, oscillation characteristic data as data concerning oscillation characteristics of the flexible object, and excitation force data as data concerning excitation force applied to the flexible object, an oscillation range shape as the flexible object model data taking into account sectional deformation of the flexible object calculated from excitation force and oscillation information and outputs the calculated oscillation range shape.

### CROSS-REFERENCE TO RELATED APPLICATION

This application is based upon and claims the benefit of priority from the prior Japanese Patent Application No. 2008-48459 filed on Feb. 28, 2008, the entire contents of which are incorporated herein by reference.

### BACKGROUND OF THE INVENTION

1. Field of the Invention

The present invention relates to a design supporting apparatus and a design supporting method.

2. Description of the Related Art

Conventionally, in designing an apparatus in which a flexible object (a harness, a cable, a hose, a belt, etc.) is set, a route through which the flexible object passes is examined and extra length sufficient for the total length of the route is set. In setting the extra length, interference and clearance verification is performed in the apparatus.

The interference and clearance verification indicates verification concerning interference (e.g., contact) between the flexible object to be set and other components and verification concerning clearance between the flexible object to be set and the other components. Specifically, for example, when the flexible object to be set and the other components come into contact with each other, a result of the interference and clearance verification is “inappropriate”. When the clearance between the flexible object to be set and the other components is too large or too small, a result of the interference and clearance verification is “inappropriate”.

In executing the interference and clearance verification, a method of manually executing the interference and clearance verification based on the experience of a designer of the apparatus in which the flexible object is set and precedents in the past or a method of using a 3-D design system (Japanese Patent No. 3974077; pages 1 to 4 and FIG. 1) employing three-dimensional computer aided design (CAD) data is used.

However, in the aforementioned conventional art, it is impossible to easily perform the interference and clearance verification taking into account the oscillation of the flexible object affected by excitation force applied to the apparatus.

For example, in the method according to the conventional art for manually executing the interference and clearance verification based on the experience of the designer and the like, it is difficult to determine optimum total length of the flexible object and substantial waste of time and labor occurs. Therefore, it is impossible to easily perform the interference and clearance verification.

For example, the method of using the 3-D design system disclosed in Japanese Patent No. 3974077 is a method of performing the interference and clearance verification for a flexible object in a stationary apparatus. The patent document does not disclose methods for solving the problem in performing the interference and clearance verification taking into account the oscillation of the flexible object affected by the excitation force applied to the apparatus.

### SUMMARY

It is an object of the present invention to at least partially solve the problems in the conventional technology.

According to an aspect of the present invention, a design supporting apparatus includes a first calculating unit that calculates an oscillation response waveform model based on flexible object model data as data concerning a flexible object fixed at least at two points, oscillation characteristic data as data concerning oscillation characteristics of the flexible object, and excitation force data as data concerning excitation force applied to the flexible object, a second calculating unit that calculates, based on the oscillation response waveform model calculated by the first calculating unit, oscillation range shape data as the flexible object model data taking sectional deformation into account, and an output unit that outputs the oscillation range shape data calculated by the second calculating unit.

According to another aspect of the present invention, a computer-implemented design supporting method includes calculating an oscillation response waveform model based on flexible object model data as data concerning a flexible object fixed at least at two points, oscillation characteristic data as data concerning oscillation characteristics of the flexible object, and excitation force data as data concerning excitation force applied to the flexible object; calculating, based on the oscillation response waveform model calculated, oscillation range shape data as the flexible object model data taking sectional deformation into account; and outputting the oscillation range shape data calculated, from an output unit.

According to still another aspect of the present invention, an electronic device designed by the design supporting method described above.

According to still another aspect of the present invention, a computer program product causes a computer to perform the design supporting method according to the present invention.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIGS. 1A to 1E are diagrams for explaining an overview and characteristics of a design supporting apparatus according to a first embodiment of the present invention;

FIG. 2 is a block diagram of a configuration of the design supporting apparatus according to the first embodiment;

FIG. 3 is a diagram for explaining nodes according to the first embodiment;

FIGS. 4A to 4D are diagrams for explaining a setting-information storing unit according to the first embodiment;

FIGS. 5A and 5B are diagrams for explaining an oscillation-information storing unit according to the first embodiment;

FIG. 6 is a diagram for explaining oscillation information according to the first embodiment;

FIG. 7 is a diagram for explaining an excitation-force-information storing unit according to the first embodiment;

FIGS. 8A and 8B are diagrams for explaining a frequency-response calculating unit and a time-axis-response calculating unit according to the first embodiment;

FIG. 9 is a diagram for explaining a maximum-displacement acquiring unit according to the first embodiment;

FIGS. 10A to 10C are diagrams for explaining an oscillation-range-shape calculating unit according to the first embodiment;

FIG. 11 is a diagram for explaining the oscillation-range-shape calculating unit according to the first embodiment;

FIG. 12 is a diagram for explaining an interference verifying unit according to the first embodiment;

FIG. 13 is a diagram for explaining a setting changing unit according to the first embodiment;

FIG. 14 is a flowchart for explaining a flow of overall processing of the design supporting apparatus according to the first embodiment;

FIG. 15 is a flowchart for explaining a flow of oscillation-range-shape calculation processing in the design supporting apparatus according to the first embodiment;

FIG. 16 is a flowchart for explaining a flow of setting change processing in the design supporting apparatus according to the first embodiment;

FIG. 17 is a flowchart for explaining a flow of processing in a design supporting apparatus according to a second embodiment of the present invention;

FIG. 18 is a diagram for explaining characteristics of a design supporting apparatus according to a third embodiment of the present invention;

FIGS. 19A to 19c are diagrams for explaining characteristics of the design supporting apparatus according to the third embodiment;

FIGS. 20A and 20B are diagrams for explaining characteristics of the design supporting apparatus according to the third embodiment;

FIGS. 21A and 21B are diagrams for explaining characteristics of the design supporting apparatus according to the third embodiment;

FIG. 22 is a flowchart for explaining a flow of processing for calculating a range shape using a minimum curvature in the design supporting apparatus according to the third embodiment;

FIG. 23 is a flowchart for explaining a flow of rotation processing in the design supporting apparatus according to the third embodiment; and

FIG. 24 is a diagram for explaining a computer program for the design supporting apparatus according to the first embodiment.

### DETAILED DESCRIPTION OF THE PREFERRED EMBODIMENTS

Exemplary embodiments of the present invention are explained in detail below with reference to the accompanying drawings.

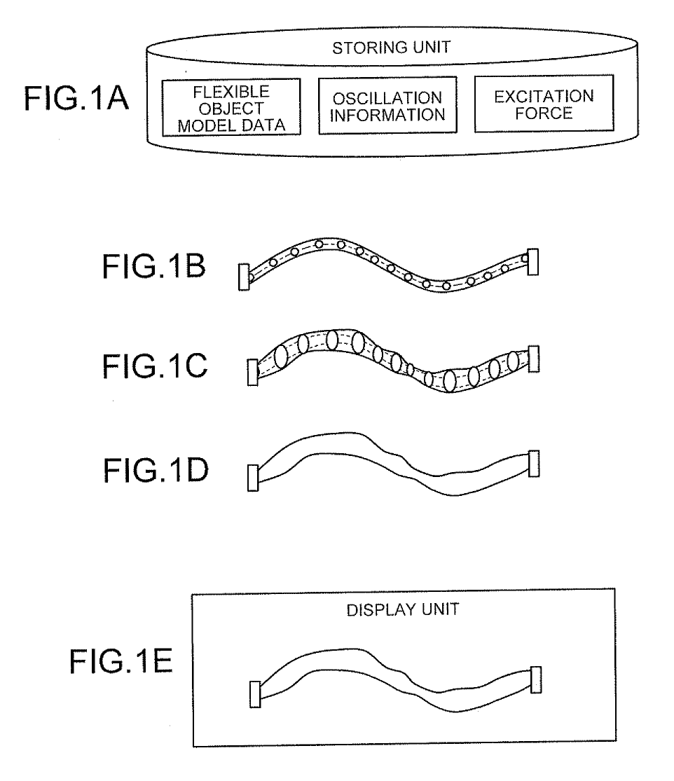

FIGS. 1A to 1E are diagrams for explaining an overview and characteristics of a design supporting apparatus according to a first embodiment of the present invention.

As shown in the figure and explained below, as a main characteristic of the design supporting apparatus according to the first embodiment, the design supporting apparatus can calculate an oscillation range shape taking into account excitation force and oscillation information (oscillation characteristics).

The design supporting apparatus according to the first embodiment calculates a sectional shape, which reflects maximum displacement, based on flexible object model data as data concerning a flexible object fixed at least at two points, oscillation information as data concerning oscillation characteristics of the flexible object, and excitation force as data concerning excitation force applied to the flexible object.

For example, as shown in FIG. 1A, the design supporting apparatus according to the first embodiment stores the flexible object model data, the oscillation information, and the excitation force in a storing unit in advance. For example, the design supporting apparatus according to the first embodiment calculates, for each of nodes, a response on a time axis (a response in a time axis domain) from the excitation force and the oscillation information taking into account the influence due to the excitation force and the oscillation information.

For example, the design supporting apparatus according to the first embodiment reads out the maximum displacement for each of the nodes. The maximum displacement is a value acquired for each of the nodes and is a value with which a response is maximized among transmitted responses on the time axis. In other words, the maximum displacement indicates a maximum position (coordinate) where each of the nodes is likely to be located when the excitation force and the oscillation information are taken into account.

For example, the design supporting apparatus according to the first embodiment reflects the read-out maximum displacement on a sectional shape of each of the nodes and calculates a sectional shape reflecting the maximum displacement. A shape of the flexible object indicated by the flexible object model data is shown in FIG. 1B. Each circle shown in FIG. 1B indicates an example of a sectional shape in each of the nodes set on the flexible object in advance. The design supporting apparatus according to the first embodiment reflects the read-out maximum displacement on the sectional shape of each of the nodes shown in FIG. 1B to thereby calculate a sectional shape reflecting the maximum displacement for each of the nodes as shown in FIG. 1C.

The design supporting apparatus according to the first embodiment calculates, based on the calculated sectional shape reflecting the maximum displacement as shown in FIG. 1C, an oscillation range shape as the flexible object model data taking into account sectional deformation due to the excitation force and the oscillation information as shown in FIG. 1D. For example, the design supporting apparatus according to the first embodiment arranges the sectional shape reflecting the maximum displacement, which is calculated for each of the nodes, in a position of each of the nodes along a center line (a track) of the flexible object as shown in FIG. 1C and calculates the oscillation range shape as shown in FIG. 1D.

The design supporting apparatus according to the first embodiment outputs the calculated oscillation range shape from an output unit. For example, the design supporting apparatus according to the first embodiment displays the calculated oscillation range shape on a display unit as shown in FIG. 1E.

Consequently, the design supporting apparatus according to the first embodiment can calculate the oscillation range information taking into account the excitation force and the oscillation information (oscillation characteristics) as indicated by the main characteristic described above.

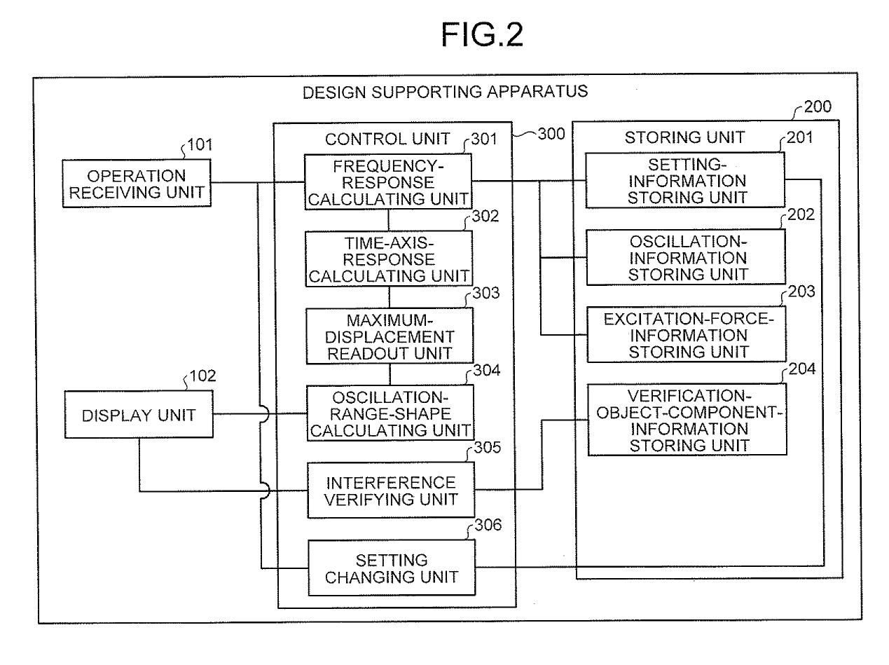

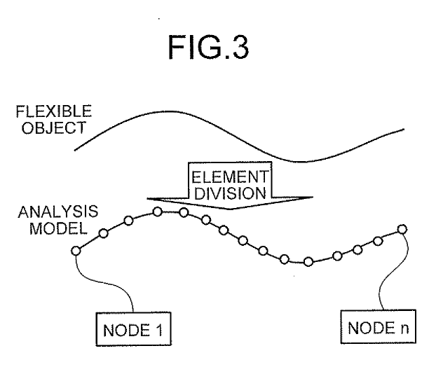

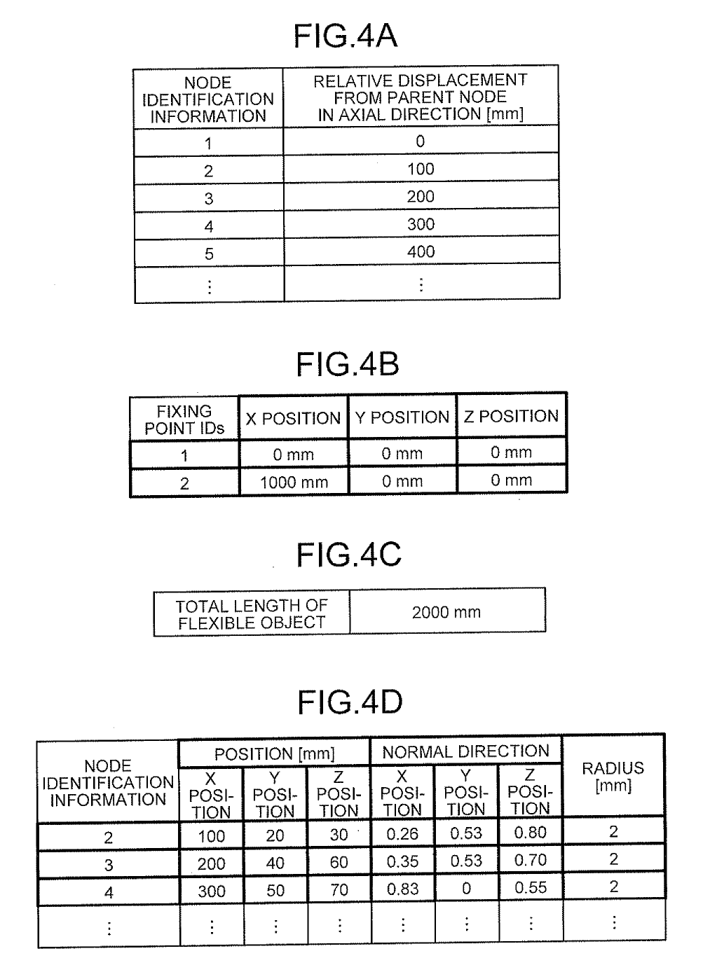

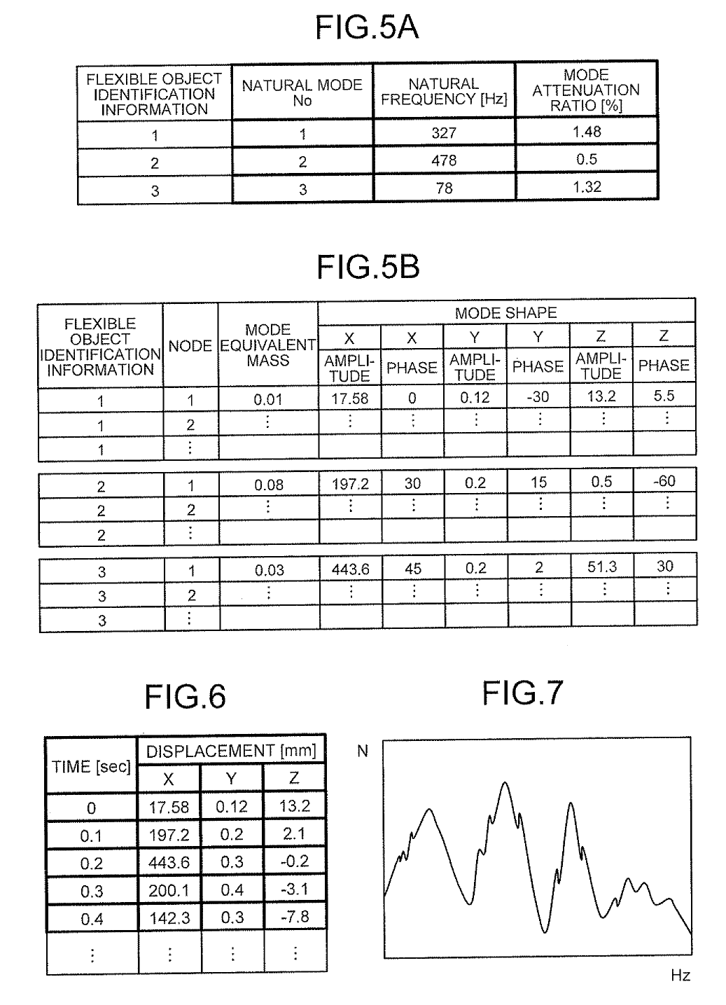

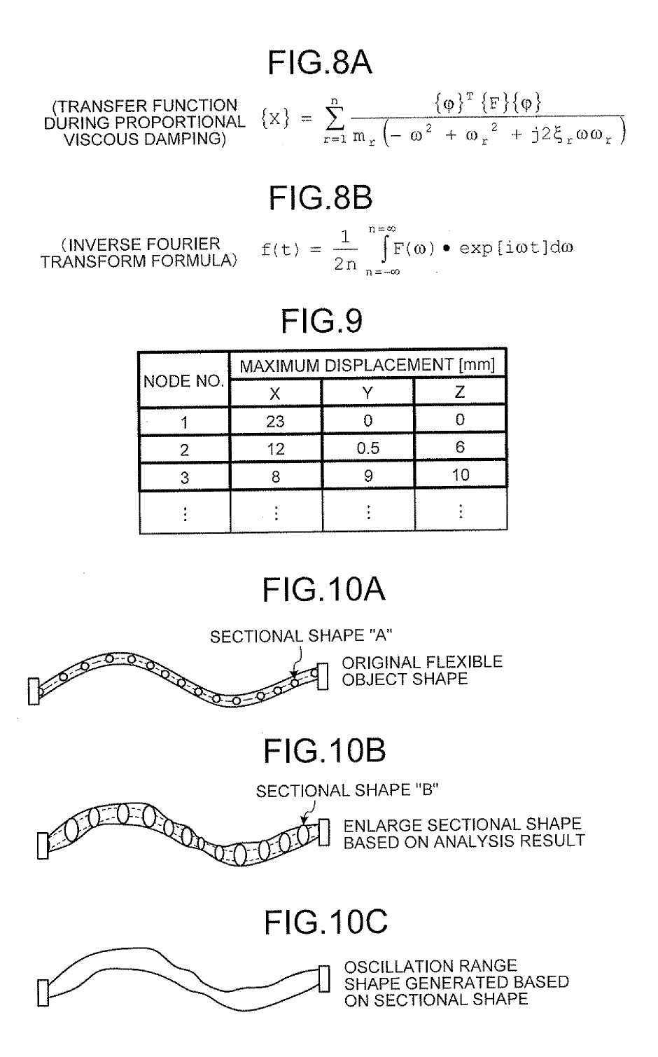

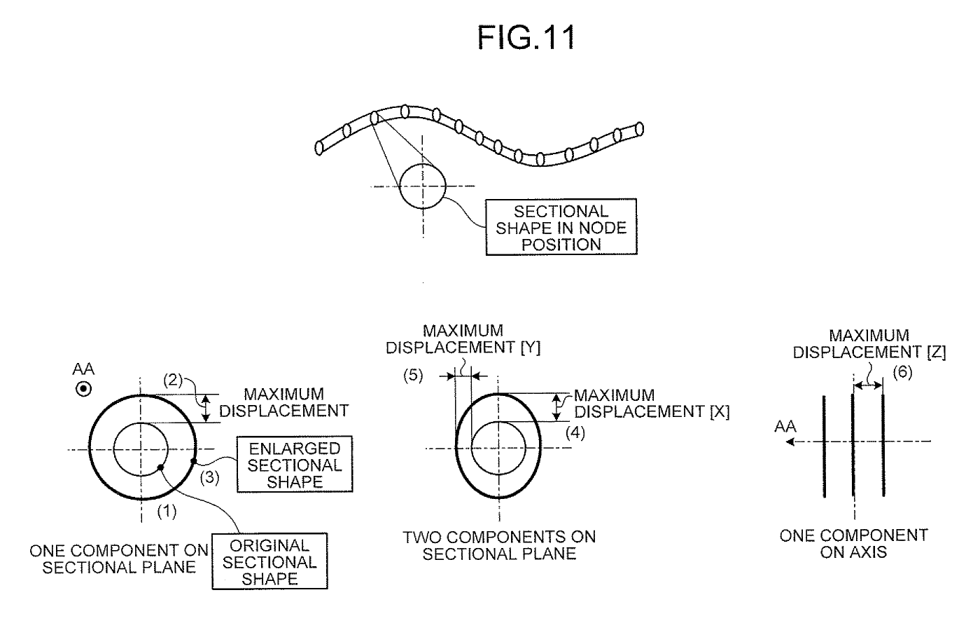

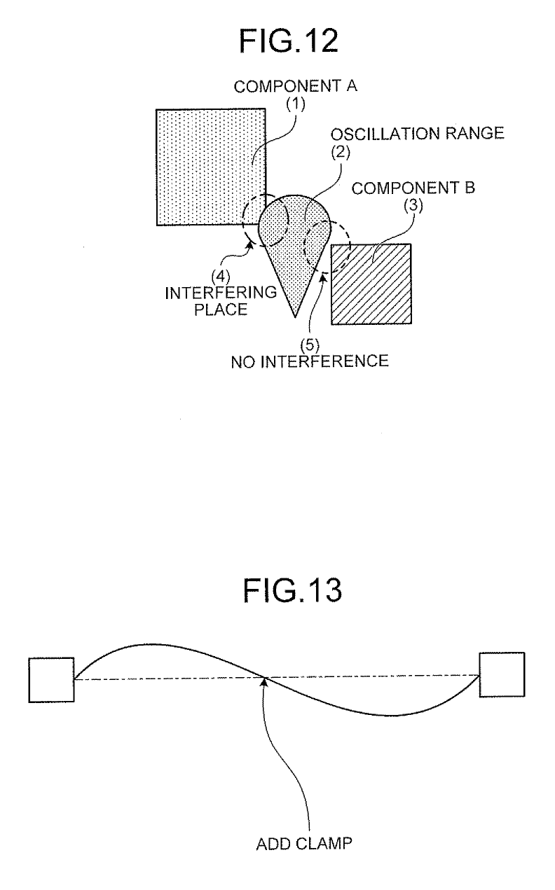

FIG. 2 is a block diagram of a configuration of the design supporting apparatus according to the first embodiment. FIG. 3 is a diagram for explaining nodes according to the first embodiment. FIGS. 4A to 4D are diagrams for explaining a setting-information storing unit according to the first embodiment. FIGS. 5A and 5B are diagrams for explaining an oscillation-information storing unit according to the first embodiment. FIG. 6 is a diagram for explaining oscillation information according to the first embodiment. FIG. 7 is a diagram for explaining an excitation-force-information storing unit according to the first embodiment. FIGS. 8A and 8B are diagrams for explaining a frequency-response calculating unit and a time-axis-response calculating unit according to the first embodiment. FIG. 9 is a diagram for explaining a maximum-displacement acquiring unit according to the first embodiment. FIGS. 10A to 10C are diagrams for explaining an oscillation-range-shape calculating unit according to the first embodiment. FIG. 11 is a diagram for explaining the oscillation-range-shape calculating unit according to the first embodiment. FIG. 12 is a diagram for explaining an interference verifying unit according to the first embodiment. FIG. 13 is a diagram for explaining a setting changing unit according to the first embodiment.

As shown in FIG. 2, the design supporting apparatus includes an operation receiving unit 101, a display unit 102, a storing unit 200, and a control unit 300. In the following explanation, a position (a coordinate) in a space in which a flexible object is set is represented by using an X axis, a Y axis, and a Z axis unless specifically noted otherwise. Specifically, in the explanation, a value on the X axis is represented as “X position”, a value on the Y axis is represented as “Y position”, and a value on the Z axis is represented as “Z position”. The X axis indicates a straight line connecting both ends of the flexible object. In the following explanation, it is assumed that both the ends of the flexible object are present on the X axis unless specifically noted otherwise. For example, in the following explanation, it is assumed that a position (a coordinate) in a space of a node 1 (a node set at an end of the flexible object) is represented by an X position of 0 (mm), a Y position of 0 (mm), and a Z position of 0 (mm).

The operation receiving unit 101 receives, from a user, operation for inputting information concerning a flexible object to be verified and transmits the received operation to a frequency-response calculating unit 301 and a setting changing unit 306 described later. For example, the operation receiving unit 101 receives information concerning the flexible object to be verified and transmits the received information to the frequency-response calculating unit 301. Specifically, for example, the operation receiving unit 101 receives flexible object identification information (information for identifying the flexible object, e.g., a flexible object ID “1”) and two fixing point IDs (information indicating points where the flexible object is fixed, e.g., fixing point IDs “1” and “2”) and transmits the received information to the frequency-response calculating unit 301.

For example, the operation receiving unit 101 receives a setting change concerning the flexible object from the user and transmits the received setting change to the setting changing unit 306. Specifically, for example, the operation receiving unit 101 receives an instruction for adding a fixing point (e.g., a clamp) and a position where the fixing point is added and transmits the received setting change to the setting changing unit 306.

The display unit 102 displays a range shape indicating a range in which the flexible object is likely to be located. Specifically, the display unit 102 displays a range shape calculated by an oscillation-range-shape calculating unit 304 described later and output to the display unit 102 (e.g., an oscillation range shape as a range shape obtained by taking into account excitation force information and oscillation information) and information (a result of interference verification) output by an interference verifying unit 305 described later. For example, a display corresponds to the display unit 102. The display unit 102 may be referred to as “the output unit”.

Specifically, for example, when an oscillation range shape is transmitted to the display unit 102 from the oscillation-range-shape calculating unit 304, the display unit 102 displays the oscillation range shape. When a verification result, which is a result of verification performed by the interference verifying unit 305, is transmitted to the display unit 102 from the interference verifying unit 305, the display unit 102 displays a result of the transmission together with the oscillation range shape transmitted from the oscillation-range-shape calculating unit 304. For example, when positions where the flexible object interferes with other components are transmitted to the display unit 102 from the interference verifying unit 305, the display unit 102 displays, together with the oscillation range shape transmitted from the oscillation-range-shape calculating unit 304, information indicating that the interference occurs in the positions. For example, when a position where clearance is inappropriate is transmitted to the display unit 102 from the interference verifying unit 305, the display unit 102 displays, together with the oscillation range shape transmitted from the oscillation-range-shape calculating unit 304, the position where the clearance is inappropriate.

The storing unit 200 stores data necessary for various kinds of processing performed by the control unit 300. In particular, as units closely related to the present invention, the storing unit 200 includes a setting-information storing unit 201, an oscillation-information storing unit 202, an excitation-force-information storing unit 203, and a verification-object-component-information storing unit 204.

The setting-information storing unit 201 stores data concerning a flexible object. Specifically, as explained below, the setting-information storing unit 201 stores in advance information indicating positions of nodes, information indicating fixing points where the flexible object is fixed, the total length of the flexible object, and information concerning a sectional shape of the flexible object.

The nodes are, as shown in FIG. 3, a plurality of points set on the flexible object in advance. The nodes are used by the control unit 300 in performing oscillation-range-shape calculation processing.

For example, as shown in FIG. 4A, the setting-information storing unit 201 stores, as information indicating positions of the nodes, an X position (e.g., when viewed in an X axis direction from a parent node (a node set at an end as a start point of the flexible object), “relative displacement” indicating relative displacement with respect to an X position of the parent node) for each kind of “node identification information” as information for identifying the nodes.

Specifically, in an example shown in FIG. 4A, the setting-information storing unit 201 stores a relative displacement of 0 (mm) in association with the node identification information “1”, stores relative a displacement of 100 (mm) in association with the node identification information “2”, and stores a relative displacement of 200 (mm) in association with the node identification information “3”.

For example, as shown in FIG. 4B, the setting-information storing unit 201 stores a position in a space for each of fixing point IDs as information indicating fixing points where the flexible object is fixed. Specifically, in an example shown in FIG. 4B, the setting-information storing unit 201 stores an X position of 0 (mm), a Y position of 0 (mm), and a Z position of 0 (mm) for the fixing point ID “1” and stores an X position of 1000 (mm), a Y position of 0 (mm), and a Z position of 0 (mm) for the fixing point ID “2”.

For example, the setting-information storing unit 201 stores the total length of the flexible object. For example, in an example shown in FIG. 4C, the setting-information storing unit 201 stores 2000 (mm) as the total length of the flexible object.

For example, as shown in FIG. 4D, the setting-information storing unit 201 stores, as information concerning a sectional shape of the flexible object, an initial position in the space, a normal direction, and a radius of the flexible object for each kind of the node identification information. Specifically, in an example shown in FIG. 4D, the setting-information storing unit 201 stores an X position of 100 (mm), a Y position of 20 (mm), and a Z position of 30 (mm) as the initial position in association with the node identification information “2”. The setting-information storing unit 201 stores an X direction of 0.26, a Y direction of 0.53, and a Z direction of 0.80 as the normal direction in association with the node identification information “2”. The setting-information storing unit 201 stores a radius of 2 (mm) in association with the node identification information “2”. The setting-information storing unit 201 stores an X position of 200 (mm), a Y position of 40 (mm), and a Z position of 60 (mm) in association with the node identification information “3”. The setting-information storing unit 201 stores an X direction of 0.35, a Y direction of 0.53, and a Z direction of 0.70 as the normal direction in association with the node identification information “3”. The setting-information storing unit 201 stores a radius of 2 (mm) in association with the node identification information “3”.

The initial position in the space for each of the nodes shown in FIG. 4D is a value that fluctuates according to the total length of the flexible object shown in FIG. 4C. When the total length of the flexible object is changed by the setting changing unit 306 described later, positions in the space are also changed by the setting changing unit 306.

The oscillation-information storing unit 202 stores oscillation information (oscillation characteristics) of flexible objects in advance. Specifically, as shown in FIGS. 5A and 5B, the oscillation-information storing unit 202 stores modal parameters for each of the flexible objects.

For example, as shown in FIG. 5A, the oscillation-information storing unit 202 stores “natural frequency (Hz)” and “mode attenuation ratio (%)” as two kinds of the modal parameters for each of the flexible objects in association with “flexible object identification information” as information for identifying the flexible objects. Specifically, in an example shown in FIG. 5A, the oscillation-information storing unit 202 stores a natural mode of 1, a natural frequency of 327, and a mode attenuation ratio of 1.48 in association with flexible object identification information “1” and stores a natural mode of 2, a natural frequency of 478, and a mode attenuation ratio of 0.5 in association with flexible object identification information “2”.

For example, as shown in FIG. 5B, the oscillation-information storing unit 202 stores “mode equivalent mass” and “mode shape” as two kinds of the modal parameters for each of nodes set for each of the flexible objects. For example, the oscillation-information storing unit 202 stores “amplitude” and “phase” as the mode shape for each of the X axis, the Y axis, and the Z axis.

Specifically, in an example shown in FIG. 5B, the oscillation-information storing unit 202 stores a mode equivalent mass of 0.01 for the flexible object identification information “1” in association with the node identification information “1”. As the mode shape, the oscillation-information storing unit 202 stores an amplitude of 17.58 and a phase of 0 for the X axis, stores an amplitude of 0.12 and a phase of −30 for the Y axis, and stores an amplitude of 13.2 and a phase of 5.5 for the Z axis.

In the explanation of the first embodiment, there is information for each of three dimensions (the X axis, the Y axis, and the Z axis) as the mode shape. However, implementation of the present invention is not limited to this. Only one dimension (e.g., the X axis) can be used or two dimensions (e.g., the X axis and the Y axis) can be used.

The excitation-force-information storing unit 203 stores an excitation force, which is an external force applied to a flexible object from the outside, in advance. For example, as shown in FIG. 7, the excitation-force-information storing unit 203 stores the excitation force in a frequency domain in advance. Specifically, for example, when the flexible object is set in an engine of an automobile, oscillation (excitation force) given to the flexible object by the oscillation of the engine corresponds to “excitation force”.

The verification-object-component-information storing unit 204 stores data concerning components set near a flexible object in advance. The components set near the flexible object are components that are objects to be verified for physical interference with the flexible object by the interference verifying unit 305. For example, the verification-object-component-information storing unit 204 stores, in association with each of the components set near the flexible object, a range in which the component is located in a space.

The information stored in the setting-information storing unit 201, the oscillation-information storing unit 202, the excitation-force-information storing unit 203, and the verification-object-component-information storing unit 204 is used by respective units of the control unit 300 described later. In the explanation of the first embodiment, for example, the information is stored in each of the storing units in advance by the user who uses the design supporting apparatus. However, the present invention is not limited to this. The storing unit can receive (or calculate) the information and use the information every time.

For example, the oscillation-information storing unit 202 is explained as storing the oscillation information in advance. However, the present invention is not limited to this. The oscillation-information storing unit 202 can calculate the oscillation information every time using a method described below. First, the oscillation-information storing unit 202 calculates a response on a time axis shown in FIG. 6 for each of the nodes using simulation or the like. In an example shown in FIG. 6, displacement concerning the node is calculated as three dimensional components (the X axis, the Y axis, and the Z axis). However, a method of calculating the oscillation information is not limited to this. For example, one-dimensional or two-dimensional components can be used according to an analysis result. The oscillation-information storing unit 20 performs simulation concerning the oscillation information using the calculated response on the time axis and calculates modal parameters as a result of the simulation.

The control unit 300 has programs defining various kinds of interference detection processing and executes the processing according to the programs. In particular, as units closely related to the present invention, the control unit 300 includes the frequency-response calculating unit 301, a time-axis-response calculating unit 302, a maximum-displacement readout unit 303, the oscillation-range-shape calculating unit 304, the interference verifying unit 305, and the setting changing unit 306. The frequency-response calculating unit 301, the time-axis-response calculating unit 302, and the maximum-displacement readout unit 303 may be collectively referred to as “a first calculating unit”. The oscillation-range-shape calculating unit 304 may be referred to as “a second calculating unit”.

The frequency-response calculating unit 301 receives information concerning a flexible object to be verified from the operation receiving unit 101 and calculates a response on a frequency axis (a response in a frequency domain) for each of the nodes. For example, the frequency-response calculating unit 301 receives flexible object identification information and two fixing point IDs from the operation receiving unit 101 and acquires, from the setting-information storing unit 201, information concerning a node set for the flexible object fixed between fixing points corresponding to the received two fixing point IDs. The frequency-response calculating unit 301 acquires oscillation information concerning the flexible object to be verified from the oscillation-information storing unit 202. The frequency-response calculating unit 301 acquires excitation force information from the excitation-force-information storing unit 203. The frequency-response calculating unit 301 substitutes the acquired information in a transfer function during proportional viscous damping shown in FIG. 8A and calculates a response on a frequency axis for each of the nodes.

Specifically, for example, the frequency-response calculating unit 301 receives a flexible object ID “1” and fixing point IDs “1” and “2” from the operation receiving unit 101. The frequency-response calculating unit 301 acquires an X position of 0 (mm), a Y position of 0 (mm), and a Z position of 0 (mm) as a position corresponding to the received fixing point ID “1” from the setting-information storing unit 201. The frequency-response calculating unit 301 acquires an X position of 1000 (mm), a Y position of 0 (mm), and a Z position of 0 (mm) as a position corresponding to the received fixing point ID “2” from the setting-information storing unit 201 (see FIG. 4B).

Specifically, for example, positions of the two fixing points are a position represented by the X position of 0 (mm), the Y position of 0 (mm), and the Z position of 0 (mm) and a position represented by the X position of 1000 (mm), the Y position of 0 (mm), and the Z position of 0 (mm). The frequency-response calculating unit 301 acquires, from the setting-information storing unit 201, node identification information “1” to “5” and the like of nodes having “relative displacement” between the X position of 0 (mm) and the X position of 1000 (mm) (see FIG. 4A).

Specifically, for example, the acquired node identification information is “1” to “5”. The frequency-response calculating unit 301 acquires a position and a radius for each of the nodes identified by the node identification information “1” to “5”. For example, the frequency-response calculating unit 301 acquires, for the node identification information “2”, the X position of 100 (mm), the Y position of 20 (mm), and the Z position of 30 (mm) from the setting-information storing unit 201 and acquires the radius of 2 (mm) from the setting-information storing unit 201 (see FIG. 4D).

Specifically, for example, the flexible object identification information is “1” and the node identification information is “1” to “5”. The frequency-response calculating unit 301 acquires, for the flexible object identification information “1”, a natural mode of 1, a natural frequency of 327, and a mode attenuation ratio of 1.48 from the oscillation-information storing unit 202 (see FIG. 5A). The frequency-response calculating unit 301 acquires, for the node identification information “1”, a mode equivalent mass of 0.01 from the oscillation-information storing unit 202. As the mode shape, the frequency-response calculating unit 301 acquires, for the X axis, an amplitude of 17.58 and a phase of 0 from the oscillation-information storing unit 202, acquires, for the Y axis, an amplitude of 0.12 and a phase of −30 from the oscillation-information storing unit 202, and acquires, for the Z axis, an amplitude of 13.2 and a phase of 5.5 from the oscillation-information storing unit 202 (see FIG. 5B).

Specifically, for example, the frequency-response calculating unit 301 acquires the excitation force information from the excitation-force-information storing unit 203, substitutes the acquired information in a formula shown in FIG. 8A, and calculates a response on the frequency axis for each of the nodes. In the formula shown in FIG. 8A, “ω” indicates the natural frequency, “ξ” indicates the mode attenuation ratio, “φ” indicates the mode shape, “m” indicates the mode equivalent mass, and “F” indicates the excitation force.

The frequency-response calculating unit 301 is informed by the setting changing unit 306 that the setting stored in the setting-information storing unit 201 is changed. The frequency-response calculating unit 301 calculates, based on the changed setting, a response on the frequency axis for each of the nodes. For example, the frequency-response calculating unit 301 is informed by the setting changing unit 306 that a rotation track radius is changed and a position of each of the nodes is changed. The frequency-response calculating unit 301 calculates a response on the frequency axis for each of the nodes using the position of each of the nodes changed by the setting changing unit 306. For example, when the frequency-response calculating unit 301 is informed by the setting changing unit 306 that a fixing point is added, the frequency-response calculating unit 301 calculates a response on the frequency axis for each of the nodes using the fixing point added anew.

After calculating the response on the frequency axis for each of the nodes, the frequency-response calculating unit 301 transmits the data acquired from the setting-information storing unit 201, the oscillation-information storing unit 202, and the excitation-force-information storing unit 203 and the calculated response on the frequency axis for each of the nodes to the time-axis-response calculating unit 302.

The time-axis-response calculating unit 302 converts the response on the frequency axis transmitted from the frequency-response calculating unit 301 into a response on a time axis (a response in a time axis domain). Specifically, the data acquired from the setting-information storing unit 201, the oscillation-information storing unit 202, and the excitation-force-information storing unit 203 by the frequency-response calculating unit 301 and the response on the frequency axis for each of the nodes calculated by the frequency-response calculating unit 301 are transmitted to the time-axis-response calculating unit 302 from the frequency-response calculating unit 301. The time-axis-response calculating unit 302 substitutes the transmitted response on the frequency axis in an inverse Fourier transform formula shown in FIG. 8B, and converts the response into a response on the time axis (for each of the nodes).

The time-axis-response calculating unit 302 transmits the data acquired from the setting-information storing unit 201, the oscillation-information storing unit 202, and the excitation-force-information storing unit 203 by the frequency-response calculating unit 301 and the response on the time axis (for each of the nodes) calculated by the time-axis-response calculating unit 302 to the maximum-displacement readout unit 303.

The maximum-displacement readout unit 303 reads out maximum displacement for each of the nodes from the transmitted response on the time axis. The maximum displacement is a value acquired for each of the nodes and is a value with which a response is maximized among transmitted responses on the time axis. In other words, the maximum displacement indicates a maximum position (coordinate) where each of the nodes is likely to be located when the excitation force information and the oscillation information are taken into account.

Specifically, the data acquired from the setting-information storing unit 201, the oscillation-information storing unit 202, and the excitation-force-information storing unit 203 by the frequency-response calculating unit 301 and the response on the time axis calculated for each of the nodes by the time-axis-response calculating unit 302 are transmitted to the maximum-displacement readout unit 303 from the time-axis-response calculating unit 302. As shown in FIG. 9, the maximum-displacement readout unit 303 reads out the maximum displacement for each of the nodes.

For example, in an example shown in FIG. 9, the maximum-displacement readout unit 303 reads out, for the node identification information “1” (a node identified by the node identification information “1”), an X position of 23 (mm), a Y position of 0 (mm), and a Z position of 0 (mm) as the maximum displacement. For example, the maximum-displacement readout unit 303 reads out, for the node identification information “2” (a node identified by the node identification information “2”), an X position of 12 (mm), a Y position of 0.5 (mm), and a Z position of 6 (mm) as the maximum displacement.

A method of reading out, as the maximum displacement, maximum values that can be taken for the three axes of the X position, the Y position, and the Z position is explained here. However, the present invention is not limited to the present invention. For example, all maximum ranges in which the respective nodes are likely to be located can be acquired. Specifically, for example, the maximum-displacement readout unit 303 can acquire, for each of the nodes, information concerning an outer periphery of positions where the node is likely to be located in a response on the time axis in the node.

The maximum-displacement readout unit 303 transmits the data acquired from the setting-information storing unit 201, the oscillation-information storing unit 202, and the excitation-force-information storing unit 203 by the frequency-response calculating unit 301 and the maximum displacement acquired for each of the nodes by the maximum-displacement readout unit 303 to the oscillation-range-shape calculating unit 304.

The oscillation-range-shape calculating unit 304 calculates an oscillation range shape indicating a range in which the flexible object is likely to be located when the oscillation information and the excitation force information are taken into account. Specifically, the data acquired from the setting-information storing unit 201, the oscillation-information storing unit 202, and the excitation-force-information storing unit 203 by the frequency-response calculating unit 301 and the maximum displacement acquired for each of the nodes by the maximum-displacement readout unit 303 are transmitted to the oscillation-range-shape calculating unit 304 from the maximum-displacement readout unit 303. As shown in FIG. 10A, the oscillation-range-shape calculating unit 304 calculates, for each of the nodes, a sectional shape (a sectional shape “A”) of the flexible object in a state in which the oscillation information and the excitation force information are not taken into account using the data acquired from the setting-information storing unit 201, the oscillation-information storing unit 202, and the excitation-force-information storing unit 203 by the frequency-response calculating unit 301. As shown in FIG. 10B, the oscillation-range-shape calculating unit 304 reflects the maximum displacement acquired by the maximum-displacement readout unit 303 on the sectional shape of the flexible object calculated for each of the nodes and calculates, for each of the nodes, a sectional shape (a sectional shape “B”) reflecting the maximum displacement (in a state in which the oscillation information and the excitation force information are taken into account). As shown in FIG. 10C, the oscillation-range-shape calculating unit 304 calculates an oscillation range shape using the sectional shape (the sectional shape “B”) reflecting the maximum displacement.

As shown in (1) of FIG. 11, the oscillation-range-shape calculating unit 304 calculates, for each of the nodes, the original sectional shape (the sectional shape “A”) from the position and the radius acquired from the setting-information storing unit 201 for each of the nodes. The oscillation-range-shape calculating unit 304 enlarges, as shown in (2) of FIG. 11, the original sectional shape (the sectional shape “B”) by the maximum displacement acquired by the maximum-displacement readout unit 303 and calculates, as shown in (3) of FIG. 11, the sectional shape (the sectional shape “B”) reflecting the maximum displacement.

For example, the maximum displacement is acquired for the three components (the X position, the Y position, and the Z position) by the maximum-displacement readout unit 303. The oscillation-range-shape calculating unit 304 reflects, as shown in (4) and (5) of FIG. 11, the maximum displacement acquired for the X position and the Y position by the maximum-displacement readout unit 303 on an X component and a Y component of the original sectional shape (the sectional shape “A”). Further, the oscillation-range-shape calculating unit 304 reflects, as shown in (6) of FIG. 11, the maximum displacement acquired for the Z position by the maximum-displacement readout unit 303 on a Z component of the original sectional shape (the sectional shape “A”). Similarly, the oscillation-range-shape calculating unit 304 performs processing for reflecting the maximum displacement on all the nodes.

Although the expression “section” is used here, this is used for a convenience in explaining the reflection of the maximum displacement on the three axes of the X position, the Y position, and the Z position. Actually, the enlarged sectional shape is calculated for each of the nodes as a range in the space.

The significance of reflecting the maximum displacement for each of the nodes is briefly explained. First, a state shown in FIG. 10A represents a state in which the influence due to the excitation force and the oscillation information is not taken into account at all (e.g., a stationary state). The sectional shape shown in (1) of FIG. 11 is a section of the node in the state. The oscillation-range-shape calculating unit 304 reflects the maximum displacement on the respective nodes in the state shown in FIG. 10A in which the influence due to the excitation force and the oscillation information is not taken into account to thereby calculate a maximum range in which the respective nodes are likely to be located when the influence due to the excitation force and the oscillation information are taken into account.

After reflecting the maximum displacement on the sectional shape (the sectional shape “A”) for the respective nodes, the oscillation-range-shape calculating unit 304 arranges the sectional shape (the sectional shape “B”) reflecting the maximum displacement in positions of the respective nodes along the center line (the track) of the flexible object (using a publicly-known sweep method) and calculates an oscillation range shape. In calculating the oscillation range shape, the oscillation-range-shape calculating unit 304 determines, using “normal direction” stored in the setting-information storing unit 201 for each of the nodes, in which direction the sectional shape reflecting the maximum displacement faces. For example, the oscillation-range-shape calculating unit 304 calculates, using simulation, the sectional shape (the sectional shape “B”) reflecting the maximum displacement in a place where the nodes are not set from the sectional shape (the sectional shape “B”) reflecting the maximum displacement (or the range in the space) and calculates an oscillation range shape.

The oscillation-range-shape calculating unit 304 transmits the calculated oscillation-range shape to the display unit 102 and the interference verifying unit 305.

The “sectional shape” and the “sectional shape reflecting the maximum displacement” are calculated for each of the nodes and indicate a range in which the flexible object at a point where the node is set is likely to be located in the space. Further, the “sectional shape” indicates a range in the stationary state. The “sectional shape reflecting the maximum displacement” indicates a maximum range in which the flexible object at the point where the node is set is likely to be located in the space in the state in which the excitation force information and the oscillation information are taken into account.

The “oscillation range” and the “oscillation range shape” are calculated for the entire flexible object and represent a range shape indicating a range in which the flexible object is likely to be located. The “oscillation range shape” is a “range shape” obtained by taking into account the excitation force information and the oscillation information. In other words, the “oscillation range shape” is a sum of “sectional shapes reflecting the maximum displacement” calculated for all points (including points where the nodes are not set) of the flexible objects. In the first embodiment, as explained above, a method of calculating, using simulation or the like, the “oscillation range shape” from “sectional shapes reflecting the maximum displacement” calculated for a plurality of nodes set in advance on the flexible object is used.

The interference verifying unit 305 verifies physical interference between the flexible object and the other components. Specifically, when the oscillation range shape is transmitted from the oscillation-range-shape calculating unit 304, the interference verifying unit 305 acquires a range in which the other components are located in the space from the verification-object-component-information storing unit 204. As shown in FIG. 12, the interference verifying unit 305 compares the range in which the other components are located in the space and the oscillation range shape transmitted from the oscillation-range-shape calculating unit 304 and verifies whether the range and the range shape overlap (interfere with) each other.

For example, when a component A and a component B are set near the flexible object, in an example shown in FIG. 12, the interference verifying unit 305 acquires a position of the component A and a position of the component B (a range in which the components A and B are located in the space) from the verification-object-component-information storing unit 204. The interference verifying unit 305 compares the position of the component A shown in (1) of FIG. 12 and the oscillation range shape transmitted from the oscillation-range-shape calculating unit 304 shown in (2) of FIG. 12 and verifies whether the two ranges overlap each other. The interference verifying unit 305 compares the position of the component B shown in (3) of FIG. 12 and the oscillation range shape shown in (2) of FIG. 12 and verifies whether the two ranges overlap each other. For example, the interference verifying unit 305 verifies that the flexible object interferes with the component A as shown in (4) of FIG. 12 or verifies that the flexible object does not interfere with the component B as shown in (5) of FIG. 12.

The interference verifying unit 305 verifies whether clearance (space) between the flexible object and the other components is a proper value as physical interference with the other components. For example, the interference verifying unit 305 stores values in a predetermined range in advance as appropriate values of the clearance. The interference verifying unit 305 verifies the clearance between the range in which the other components are located in the space, which is acquired from the verification-object-component-information storing unit 204, and the flexible object and judges whether a distance between the other components and the flexible object is within the values in the predetermined range stored in advance. When the distance between the other components and the flexible object is within the predetermined range, the interference verifying unit 305 verifies that the clearance is appropriate. When the distance is not within the predetermined range, the interference verifying unit 305 verifies that the clearance is in appropriate.

The interference-verifying unit 305 transmits a result of the verification to the display unit 102. For example, when the range in which the other components are located in the space and the range shape overlap each other, the interference verifying unit 305 transmits an overlapping position to the display unit 102. When the range and the range shape do not overlap each other, the interference verifying unit 305 informs the display unit 102 that the flexible object does not interfere with the other components. When the clearance is inappropriate, the interference verifying unit 305 transmits a position where the clearance is inappropriate to the display unit 102. When the clearance is appropriate, the interference verifying unit 305 informs the display unit 102 that the clearance is appropriate.

The setting changing unit 306 performs a setting change for the flexible object. For example, the setting changing unit 306 receives a setting change by the user from the operation receiving unit 101 and reflects content of the received change on the setting-information storing unit 201. For example, when the setting changing unit 306 receives an instruction for adding a fixing point (e.g., a clamp) and a position where the fixing point is added as shown in FIG. 13, the setting changing unit 306 adds the received position to the setting-information storing unit 201 (see FIG. 4B).

The setting changing unit 306 receives the setting change from the operation receiving unit 101 and performs the setting change. The setting changing unit 306 informs the frequency-response calculating unit 301 that the setting change is performed. For example, when the fixing point is added, the setting changing unit 306 informs the frequency-response calculating unit 301 that the fixing point is added.

This design supporting apparatus can be realized by mounting, in a known information processing apparatus such as a personal computer or a workstation, the functions of the setting-information storing unit 201, the oscillation-information storing unit 202, the excitation-force-information storing unit 203, the frequency-response calculating unit 301, the time-axis-response calculating unit 302, the maximum-displacement readout unit 303, the oscillation-range-shape calculating unit 304, the interference verifying unit 305, and the setting changing unit 306.

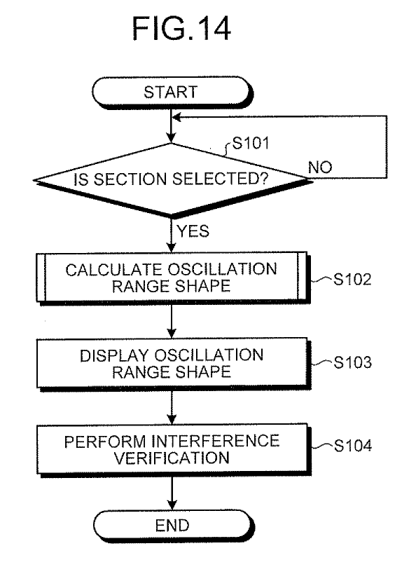

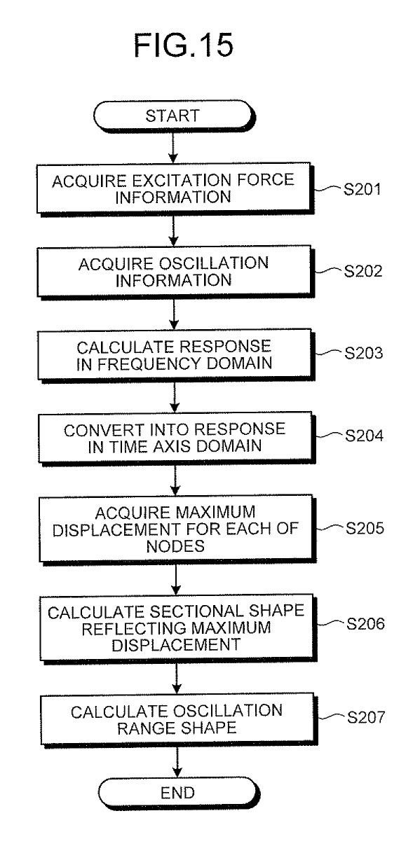

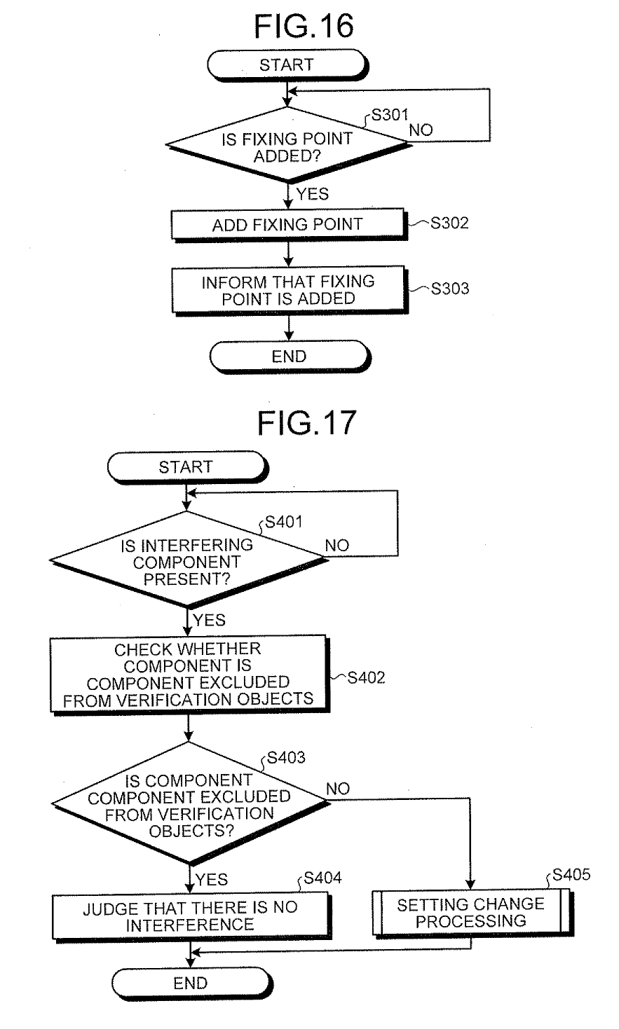

FIG. 14 is a flowchart for explaining a flow of overall processing of the design supporting apparatus according to the first embodiment. FIG. 15 is a flowchart for explaining a flow of oscillation-range-shape calculation processing in the design supporting apparatus according to the first embodiment. FIG. 16 is a flowchart for explaining a flow of setting change processing in the design supporting apparatus according to the first embodiment.

As shown in FIG. 14, in the disclosed design supporting apparatus, a section is selected (“Yes” at step S101), i.e., for example, the operation receiving unit 101 receives information concerning the flexible object to be verified and the received information is transmitted from the operation receiving unit 101 to the frequency-response calculating unit 301. The frequency-response-calculating unit 301 calculates an oscillation range shape (step S102). In other words, for example, in the disclosed design supporting apparatus, the oscillation range shape is calculated by the frequency-response calculating unit 301, the time-axis-response calculating unit 302, the maximum-displacement readout unit 303, and the oscillation-range-shape calculating unit 304.

The display unit 102 displays the calculated oscillation range shape (step S103). Specifically, the oscillation-range-shape calculating unit 304 transmits the calculated oscillation range shape to the display unit 102 and the display unit 102 displays the transmitted oscillation range shape. The interference verifying unit 305 performs interference verification (step S104). The oscillation range shape is transmitted to the interference verifying unit 305 from the oscillation-range-shape calculating unit 304. The interference verifying unit 305 acquires the range in which the other components are located in the space from the verification-object-component-information storing unit 204. The interference verifying unit 305 compares the range in which the other components are located in the space and the oscillation range shape transmitted from the oscillation-range-shape calculating unit 304 and verifies whether the range and the range shape overlap each other (interfere with each other).

As shown in FIG. 15, the frequency-response calculating unit 301 acquires excitation force information (step S201) and acquires oscillation information (step S202). The frequency-response calculating unit 301 acquires, from the excitation-force-information storing unit 203, excitation force information corresponding to information concerning the flexible object to be verified transmitted from the operation receiving unit 101 and acquires, from the oscillation-information storing unit 202, oscillation information corresponding to the information concerning the flexible object.

The frequency-response calculating unit 301 calculates a response in the frequency domain (step S203). For example, the frequency-response calculating unit 301 substitutes the excitation force information and the oscillation information acquired at steps S201 and S202 and the information concerning the flexible object acquired from the setting-information storing unit 201 in the transfer function during proportional viscous damping (see FIG. 8A) and calculates a response on the frequency axis for each of the nodes.

The time-axis-response calculating unit 302 converts the response in the frequency domain calculated by the frequency-response calculating unit 301 into a response in the time axis domain (step S204). For example, the response on the frequency axis for each of the nodes calculated by the frequency-response calculating unit 301 is transmitted to the time-axis-response calculating unit 302 from the frequency-response calculating unit 301. The time-axis-response calculating unit 302 substitutes the transmitted response on the frequency axis in the inverse Fourier transform formula and converts the response on the frequency axis into a response on the time axis (for each of the nodes).

The maximum-displacement readout unit 303 acquires maximum displacement for each of the nodes (step S205). When the response on the time axis (for each of the nodes) calculated by the time-axis-response calculating unit 302 is transmitted to the maximum-displacement readout unit 303 from the time-axis-response calculating unit 302, the maximum-displacement readout unit 303 acquires maximum displacement for each of the nodes. For example, the maximum-displacement readout unit 303 acquires, as the maximum displacement, maximum displacements for the three axes of the X position, the Y position, and the Z position.

The oscillation-range-shape calculating unit 304 calculates, for each of the nodes, a sectional shape reflecting the maximum displacement (step S206). For example, the maximum displacement is transmitted to the oscillation-range-shape calculating unit 304 from the maximum-displacement readout unit 303. The oscillation-range-shape calculating unit 304 calculates, for each of the nodes, the sectional shape (the sectional shape “A”) of the flexible object in the state in which the oscillation information and the excitation force information are not taken into account (see FIG. 10A). The oscillation-range-shape calculating unit 304 reflects the transmitted maximum displacement on the sectional shape (the sectional shape “A”) calculated for each of the nodes and calculates, for each of the nodes, the sectional shape (the sectional shape “B”) reflecting the maximum displacement (see FIG. 10B).

The oscillation-range-shape calculating unit 304 calculates an oscillation range shape (step S207). The oscillation-range-shape calculating unit 304 calculates an oscillation range shape using the sectional shape (the sectional shape “B”) reflecting the maximum displacement. For example, the oscillation-range-shape calculating unit 304 calculates, from the sectional shape (the sectional shape “B”) reflecting the maximum displacement, the sectional shape (the sectional shape “B”) reflecting the maximum displacement in a place where the nodes are not set and calculates an oscillation range shape using simulation.

As shown in FIG. 16, when a fixing point is added (“Yes” at step S301), i.e., for example, the setting changing unit 306 receives an instruction for adding a fixing point (e.g., a clamp) and a position where the fixing point is added, the setting changing unit 306 adds the received position to the setting-information storing unit 201 (step S302). The setting changing unit 306 informs the frequency-response calculating unit 301 that the position is added (step S303).

As explained above, according to the first embodiment, because a range shape is calculated based on the oscillation information and the excitation force, it is possible to calculate an oscillation range shape taking into account the excitation force and the oscillation information (oscillation characteristics).

Further, because physical interference with other component data is verified based on the calculated oscillation range shape, it is possible to easily perform interference and clearance verification taking into account the oscillation of the flexible object affected by the excitation force applied to the apparatus. For example, compared with the method in the past, it is possible to verify interference in a state closer to the reality in which oscillation and the like are taken into account.

Specifically, for example, concerning a flexible object set in an apparatus that frequently oscillates such as an automobile, it is possible to verify whether the flexible object interferes with other components and execute interference and clearance verification for a space between the flexible object and the other components taking into account the oscillation of the flexible object due to excitation force (oscillation, etc.) applied to the apparatus.

The method of verifying interference without specifically limiting components for which interference is verified is explained above as the first embodiment. However, the present invention is not limited to this. Components for which interference is verified can be limited to a part of all components.

Therefore, a method of limiting components for which interference is verified to a part of all components is explained below as a second embodiment of the present invention with reference to FIG. 17. Similarities to the design supporting apparatus according to the first embodiment are briefly explained or explanation of the similarities is omitted. FIG. 17 is a flowchart for explaining a flow of processing in the design supporting apparatus according to the second embodiment.

The design supporting apparatus according to the second embodiment further includes an out-of-object-component-data storing unit (not shown in FIG. 2) that stores in advance data concerning components excluded from objects for which interference is verified. For example, the out-of-object-component-data storing unit stores in advance, in association with each of components stored in the verification-object-component-information storing unit 204, information indicating components as objects for which interference is verified or information indicating components excluded from objects for which interference is verified.

In the design supporting apparatus according to the second embodiment, the interference verifying unit 305 verifies physical interference only for components other than the components stored in the out-of-object-component-data storing unit. Specifically, the interference verifying unit 305 verifies interference, among the components stored in the verification-object-component-information storing unit 204, only for components stored by the out-of-object-component-data storing unit in association with information indicating components as objects for which interference is verified.

For example, in an example shown in FIG. 17, in the design supporting apparatus according to the second embodiment, when there is a component that interferes with the flexible object (“Yes” at step S401), the interference verifying unit 305 checks whether the component is a component excluded from verification objects (step S402). When the component is a component excluded from the verification objects (“Yes” at step S403), the interference verifying unit 305 judges that the component does not interfere with the flexible object (step S404). For example, even if the component is a component that interferes with the flexible object, the interference verifying unit 305 performs processing assuming that there is no interference with the component. On the other hand, when the component is a component as a verification object (“No” at step S403), for example, the interference verifying unit 305 performs setting change processing (step S405).

In the second embodiment, the method of storing in advance information indicating components as objects for which interference is verified or information indicating components excluded from the objects for which interference is verified is explained. However, the present invention is not limited to this. Information can be received from the user and used every time interference is verified.

As explained above, according to the second embodiment, the design supporting apparatus further includes the out-of-object-component-data storing unit that stores in advance data concerning the components excluded from the objects for which interference is verified. The interference verifying unit 305 verifies physical interference only for components other than the components stored in the out-of-object-component-data storing unit. Therefore, it is possible to execute interference verification only for components for which interference needs to be verified.

In the explanation of the first and second embodiments, only the method of using the excitation force information and the oscillation information is used as a method of calculating a range shape. However, the present invention is not limited to this. A design supporting apparatus according to a third embodiment of the present invention can use other methods.

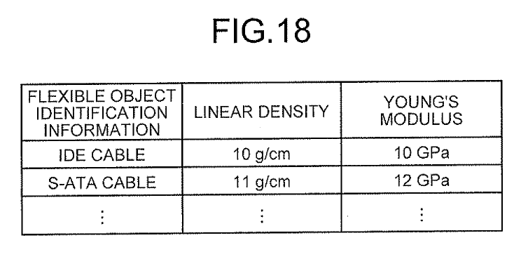

Therefore, a design supporting apparatus that uses other methods is explained below as the third embodiment with reference to FIGS. 18 to 24. Specifically, a design supporting apparatus that uses a method of calculating a range shape of a flexible object using a minimum curvature is explained. In the following explanation, similarities to the design supporting apparatus according to the first or second embodiment are briefly explained or explanation of the similarities is omitted.

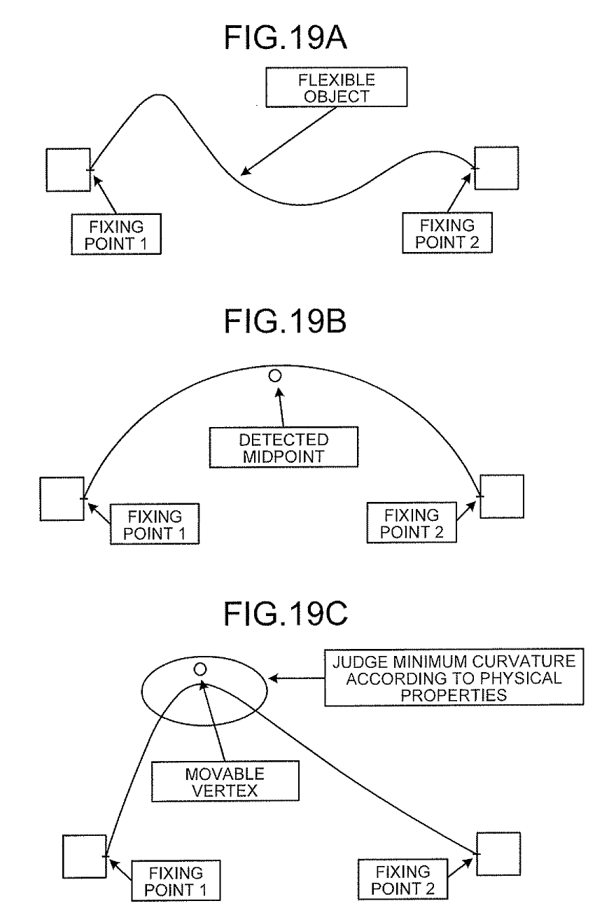

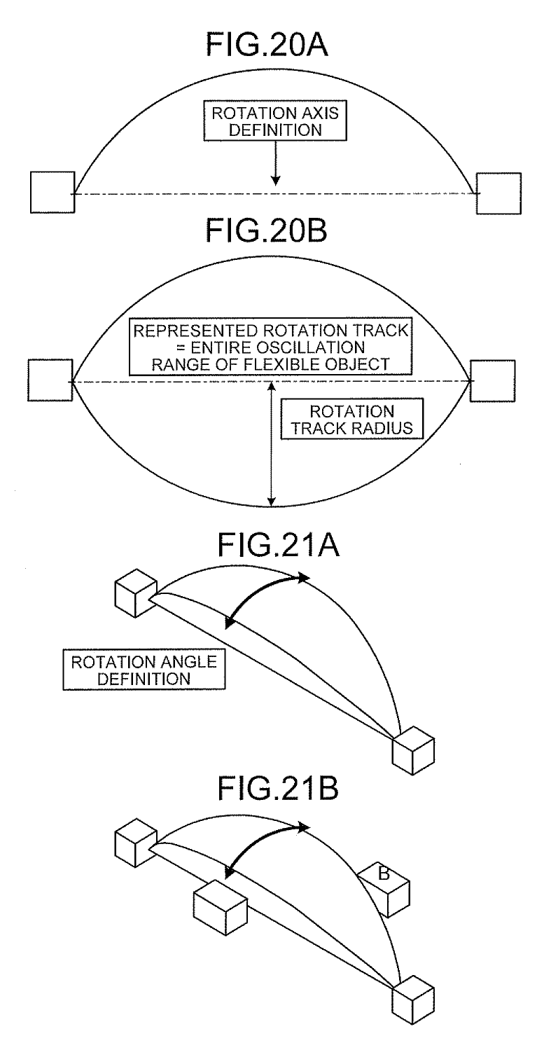

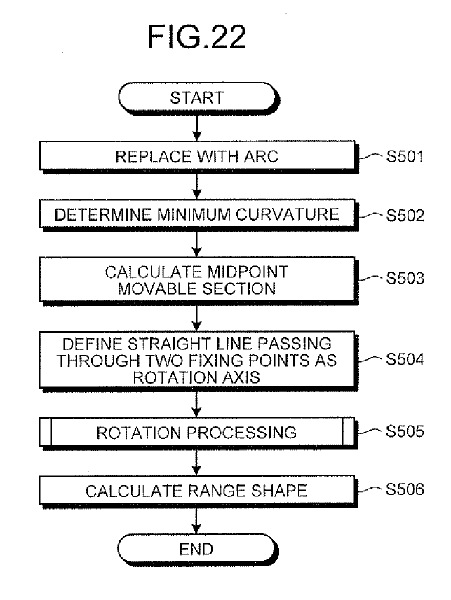

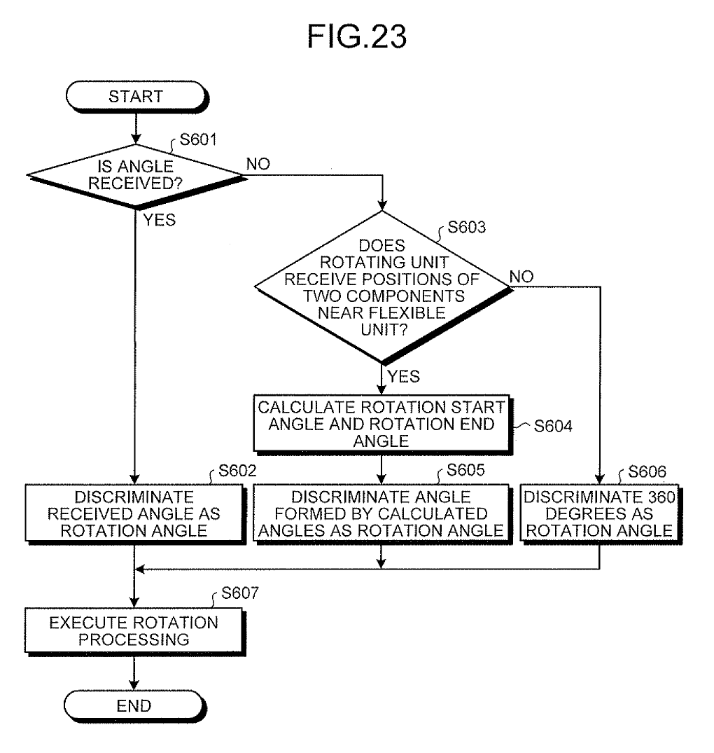

FIG. 18 is a diagram for explaining characteristics of a design supporting apparatus according to the third embodiment. FIGS. 19A to 19C are diagrams for explaining characteristics of the design supporting apparatus according to the third embodiment. FIGS. 20A and 20B are diagrams for explaining characteristics of the design supporting apparatus according to the third embodiment. FIGS. 21A and 21B are diagrams for explaining characteristics of the design supporting apparatus according to the third embodiment. FIG. 22 is a flowchart for explaining a flow of processing for calculating a range shape using a minimum curvature in the design supporting apparatus according to the third embodiment. FIG. 23 is a flowchart for explaining a flow of rotation processing in the design supporting apparatus according to the third embodiment.

The design supporting apparatus according to the third embodiment performs calculation of a range shape using a minimum curvature explained below instead of performing the processing for calculating an oscillation range shape, for example, when there is no excitation force information or oscillation information or when an instruction of a user for calculating a range shape using a minimum curvature is received.

As shown in FIG. 18, the design supporting apparatus according to the third embodiment stores physical property information of a flexible object. For example, in an example shown in FIG. 18, linear density and a Young's modulus are stored as the physical property information in association with flexible object identification information. Specifically, the linear density “10 g/cm” and the Young's modulus “10 GPa” are stored in association with the flexible object identification information “IDE cable”.

The design supporting apparatus (an arc creating unit) according to the third embodiment receives information concerning a flexible object to be verified from the operation receiving unit 101. The design supporting apparatus replaces a flexible object fixed at two fixing points (in an example shown in FIGS. 19A to 19C, “fixing point 1” and “fixing point 2”) as shown in FIG. 19A with an arc having a straight line passing through the two fixing points as an axis as shown in FIG. 19B.

The arcuate circumference of the arc is equal to the total length of the flexible object. A vertex (a point indicating a largest value on an axis orthogonal to the axis formed by the straight line passing through the two fixing points) among points on the arc is described as “midpoint” below. A range in which the “midpoint” can move (a range in which the “midpoint” can be located” is determined by a minimum curvature of the flexible object as shown in FIG. 19C. The minimum curvature is determined from physical properties of the flexible object. For example, the minimum curvature is uniquely determined by the linear density and the Young's ratio.

In replacing the flexible object with the arc having the straight line passing through the two fixing point as the axis as shown in FIG. 19B, the design supporting apparatus (the arc creating unit) according to the third embodiment acquires physical property information concerning the flexible object stored in association with “flexible object identification information” for identifying the flexible object and determines a minimum curvature. The arc creating unit maintains the minimum curvature and, then, calculates (acquires) a midpoint movable section as a section in a range in which the “midpoint” is movable on a plane (a section in a range in which the “midpoint” can be located).

When the midpoint movable section is calculated by the arc creating unit, as shown in FIG. 20A, the design supporting apparatus (a rotating unit) according to the third embodiment sets, as a rotation axis, the straight line passing through the two fixing points where the flexible object is fixed. As shown in FIG. 20B, the design supporting apparatus (the rotating unit) rotates the midpoint movable section calculated by the arc creating unit using the set rotation axis and calculates a range shape as a range in which the flexible object can be located.

In rotating the midpoint movable section calculated by the arc creating unit using the set rotation axis as shown in FIG. 21A, the design supporting apparatus (the rotating unit) according to the third embodiment discriminates a rotation angle, rotates the midpoint movable section using the discriminated rotation angle, and calculates a range shape as a range in which the flexible object can be located.

For example, in the design supporting apparatus according to the third embodiment, the operation receiving unit 101 receives a start angle as an angle for starting the rotation and an end angle as an angle for ending the rotation from the user and transmits the received angles to the rotating unit. The rotating unit discriminates an angle formed by the transmitted angles as a rotation angle, rotates the midpoint movable section calculated by the arc creating unit using the rotation angle, and calculates a range obtained by the rotation as a range shape.

For example, in the design supporting apparatus according to the third embodiment, the operation receiving unit 101 receives positions of two components near the flexible object from the user and transmits the received positions of the two components to the rotating unit. As shown in FIG. 20B, the rotating unit calculates a rotation start angle and a rotation end angle indicating a range specified by the transmitted positions of the two components and discriminates an angle formed by the calculated rotation start angle and the rotation end angle as a rotation angle. The rotating unit rotates the midpoint movable section calculated by the arc creating unit using the rotation angle and calculates a range obtained by the rotation as a range shape.

For example, in the design supporting apparatus according to the third embodiment, when the operation receiving unit 101 receives no information concerning a rotation start angle and a rotation end angle from the user and no information concerning a rotation start angle and a rotation end angle is transmitted to the rotating unit from the operation receiving unit 101, the rotating unit discriminates that a rotation angle is 360 degrees (one round). The rotating unit rotates the midpoint movable section calculated by the arc creating unit using the rotation angle and calculates a range obtained by the rotation as a range shape.

In the design supporting apparatus according to the third embodiment, the interference verifying unit 305 verifies interference using the range shape calculated by the rotating unit.

In the design supporting apparatus according to the third embodiment, the operation receiving unit 101 receives an instruction for changing a rotation track radius and a value of the rotation track radius to be changed and transmits the received content to the setting changing unit 306.

In the design supporting apparatus according to the third embodiment, for example, the instruction for changing a rotation track radius and the value of the rotation track radius to be changed are transmitted to the setting changing unit 306 from the operation receiving unit 101. The setting changing unit 306 calculates the total length of the flexible object from the changed rotation track radius, changes the total length of the flexible object stored in the setting-information storing unit 201 to the calculated value, and changes the positions of the nodes stored in the setting-information storing unit 201. When the rotation track radius is changed, the setting changing unit 306 informs the frequency-response calculating unit 301 that the rotation track radius is changed. The frequency-response calculating unit 301 starts frequency-response calculation processing using the changed setting.

A flow of processing of the design supporting apparatus according to the third embodiment is explained with reference to FIGS. 22 and 23. First, a flow of processing for calculating a range shape is explained with reference to FIG. 22. The flow of the processing explained with reference to FIG. 22 is carried out instead of the flow of calculation of an oscillation range shape in the design supporting apparatus according to the first embodiment shown in FIG. 15. Like the flow of the series of processing shown in FIG. 15, the flow of the processing is executed at step S102 shown in FIG. 14.

In the design supporting apparatus according to the third embodiment, the arc creating unit replaces a shape of the flexible object with an arc (step S501). For example, when the arc creating unit receives information concerning the flexible object to be verified, the arc creating unit replaces the flexible object fixed at two fixing points with an arc having a straight line passing through the two fixing points as an axis (see FIG. 19B).

In the design supporting apparatus according to the third embodiment, the arc creating unit determines a minimum curvature (step S502). For example, the arc creating unit acquires physical property information concerning the flexible object stored in association with “flexible object identification information” for identifying the flexible object and determines a minimum curvature. The arc creating unit calculates a midpoint movable section (step S503).

In the design supporting apparatus according to the third embodiment, the rotating unit defines the straight line passing through the two fixing points as a rotation axis (step S504) and executes rotation processing (step S505). For example, when the midpoint movable section is calculated by the arc creating unit, the rotating unit sets the straight line passing through the two fixing points, where the flexible object is fixed, as a rotation axis (see FIG. 20A) and rotates the midpoint movable section calculated by the arc creating unit using the set rotation axis (see FIG. 20B). The rotating unit calculates a range shape as a range in which the flexible object can be located (step S506).

A flow of rotation processing is explained with reference to FIG. 23.

In the design supporting apparatus according to the third embodiment, in rotating the midpoint movable section calculated by the arc creating unit, the rotating unit receives an angle from the user (“Yes” at step S601). For example, an angle received by the operation receiving unit 101 is transmitted from the operation receiving unit 101 to the rotating unit. The rotating unit discriminates the transmitted angle as a rotation angle (step S602).

The rotating unit does not receive an angle from the user (“No” at step S602) and receives positions of two components near the flexible unit (“Yes” at step S603). For example, the positions of the two components received by the operation receiving unit 101 are transmitted from the operation receiving unit 101 to the rotating unit. The rotating unit calculates a rotation start angle and a rotation end angle indicating a range specified by the transmitted positions of the two components (step S604) and discriminates an angle formed by the rotation start angle and the rotation end angle as a rotation angle (step S605).

When the rotating unit does not receive an angle from the user (“No” at step S601) and does not receive positions of two components near the flexible object (“No” at step S603), the rotating unit discriminates that a rotation angle is 360 degrees (step S606).

The rotating unit executes the rotation processing using the discriminated rotation angle (step S607). For example, the rotating unit rotates the midpoint movable section calculated by the arc creating unit using the rotation angle and calculates a range shape as a range in which the flexible object can be located.

As explained above, according to the third embodiment, the design supporting apparatus calculates, when the oscillation characteristic data or the excitation force data is not present, a waveform model based on a minimum curvature calculated from material physical properties of the flexible object and rotates the calculated waveform model at a specified angle to calculate a range shape (rotation waveform data). The interference verifying unit 305 verifies physical interference with other component data based on the range shape (rotation waveform data). Therefore, the disclosed design supporting apparatus can verify the physical interference even when there is no excitation force or oscillation information.

The embodiments of the present invention have been explained. However, the present invention can be carried out in various different forms other than the embodiments described above. Therefore, other embodiments are explained below.

In the first embodiment, the method of carrying out both the method of calculating an oscillation range shape using excitation force information and oscillation information and the method of verifying interference is explained. However, the present invention is not limited to this. Only the method of calculating an oscillation range shape using excitation force information and oscillation information can be carried out. Similarly, the methods explained in the second and third embodiments can be carried out together with only the method of calculating an oscillation range shape using excitation force information and oscillation information.

Among the respective kinds of processing explained in the embodiments, all or a part of the kinds of processing explained as being automatically performed (e.g., the interference verification processing) can be manually performed. The processing procedures, the control procedures, the specific names, and the information including various data and parameters (e.g., FIGS. 1 to 24) described in the specification and shown in the drawings can be arbitrarily changed unless specifically noted otherwise.

The respective components of the respective devices shown in the figures are functionally conceptual and are not always required to be physically configured as shown in the figures. In other words, specific forms of distribution and integration of the devices are not limited to those shown in the figures. All or a part of the devices can be functionally or physically distributed and integrated in arbitrary units according to various loads and states of use.

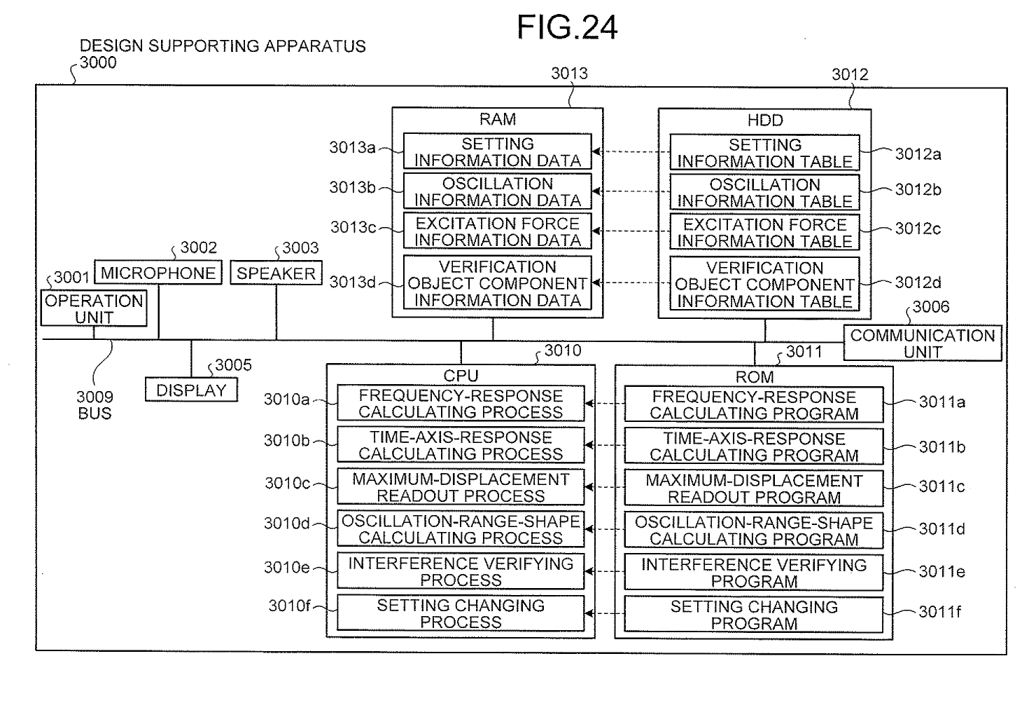

In the first embodiment, the various kinds of processing are realized by a hardware logic. However, the present invention is not limited to this. The processing can be realized by executing programs prepared in advance using a computer. Therefore, an example of a computer that executes a design supporting program having functions same as those of the design supporting apparatus described in the first embodiment is explained below with reference to FIG. 24. FIG. 24 is a diagram for explaining a computer program for the design supporting apparatus according to the first embodiment.

As shown in the figure, a design supporting apparatus 3000 according to the first embodiment is configured by connecting an operation unit 3001, a microphone 3002, a speaker 3003, a display 3005, a communication unit 3006, a central processing unit (CPU) 3010, a read only memory (ROM) 3011, a hard disk (HD) 3012, and a random access memory (RAM) 3013 through a bus 3009 or the like.

The ROM 3011 have stored therein in advance control programs that display functions same as those of the frequency-response calculating unit 301, the time-axis-response calculating unit 302, the maximum-displacement readout unit 303, the oscillation-range-shape calculating unit 304, the interference verifying unit 305, and the setting changing unit 306 explained in the first embodiment. The control programs are, as shown in the figure, a frequency-response calculating program 3011a, a time-axis-response calculating program 3011b, a maximum-displacement readout program 3011c, an oscillation-range-shape calculating program 3011d, an interference verifying program 3011e, and a setting changing program 3011f. The programs 3011a to 3011f can be integrated or distributed as appropriate in the same manner as the components of the design supporting apparatus shown in FIG. 2.

The CPU 3010 reads out the programs 3011a to 3011f from the ROM 3011 and executes the programs 3011a to 3011f. Consequently, as shown in FIG. 24, the programs 3011a to 3011f function as a frequency-response calculating process 3010a, a time-axis-response calculating process 3010b, a maximum-displacement readout process 3010c, an oscillation-range-shape calculating process 3010d, an interference verifying process 3010e, and a setting changing process 3010f. The processes 3010a to 3010f correspond to the frequency-response calculating unit 301, the time-axis-response calculating unit 302, the maximum-displacement readout unit 303, the oscillation-range-shape calculating unit 304, the interference verifying unit 305, and the setting changing unit 306 shown in FIG. 2, respectively.

In the HD 3012, a setting information table 3012a, an oscillation information table 3012b, an excitation force information table 3012c, and a verification object component information table 3012d are provided. The tables 3012a to 3012d correspond to the setting-information storing unit 201, the oscillation-information storing unit 202, the excitation-force-information storing unit 203, and the verification-object-component-information storing unit 204, respectively.

The CPU 3010 reads out the setting information table 3012a, the oscillation information table 3012b, the excitation force information table 3012c, and the verification object component information table 3012d and stores the tables in the RAM 3013. The CPU 3010 executes the design supporting program using setting information data 3013a, oscillation information data 3013b, excitation force information data 3013c, and verification object component information data 3013d stored in the RAM 3013.

The design supporting apparatus explained in the embodiments can be realized by executing programs prepared in advance using a computer such as a personal computer or a workstation. The programs can be distributed via a network such as the Internet. The programs can be recorded in a computer-readable recording medium such as a hard disk, a flexible disk (FD), a compact disc-read only memory (CD-ROM), a magneto-optical disk (MO), or a digital versatile disk (DVD) and executed by being read out from the recording medium by the computer.

With the disclosed design supporting apparatus, it is possible to calculate an oscillation range shape taking into account excitation force and oscillation information (oscillation characteristics).

With the disclosed design supporting apparatus, it is possible to easily perform the interference and clearance verification taking into account the oscillation of the flexible object affected by the excitation force applied to the apparatus.

Further, with the disclosed design supporting apparatus, it is possible to execute the interference verification only for components for which interference needs to be verified.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A design supporting apparatus comprising:
a first calculating unit that calculates an oscillation response waveform model based on flexible object model data as data concerning a flexible object fixed at least at two points, oscillation characteristic data as data concerning oscillation characteristics of the flexible object, and excitation force data as data concerning excitation force applied to the flexible object;
a second calculating unit that calculates, based on the oscillation response waveform model calculated by the first calculating unit, oscillation range shape data as the flexible object model data taking sectional deformation into account; and
an output unit that outputs the oscillation range shape data calculated by the second calculating unit.

2. The design supporting apparatus according to claim 1, further comprising an interference verifying unit that verifies physical interference with other component data based on the oscillation range shape data calculated by the second calculating unit.

3. The design supporting apparatus according to claim 2, further comprising an out-of-object-component-data storing unit that stores in advance data concerning components excluded from objects for which interference is verified, wherein
the interference verifying unit verifies physical interference only for components other than the components stored in the out-of-object-component-data storing unit.

4. The design supporting apparatus according to claim 1, wherein the flexible object mode data is data obtained when any one of a cable and a harness or both are used as the flexible object.

5. The design supporting apparatus according to claim 2, further comprising:
a waveform calculating unit that calculates, when the oscillation characteristic data or the excitation force data is not present, a waveform model based on a minimum curvature calculated from material physical properties of the flexible object; and
a rotation-waveform calculating unit that calculates rotation waveform data as data obtained by rotating the waveform model, which is calculated by the waveform calculating unit, at a specified angle, wherein
the interference verifying unit verifies physical interference with other component data based on the oscillation range shape data calculated by the second calculating unit or the rotation waveform data calculated by the rotation-waveform calculating unit.

6. A computer-implemented design supporting method, comprising:
calculating an oscillation response waveform model based on flexible object model data as data concerning a flexible object fixed at least at two points, oscillation characteristic data as data concerning oscillation characteristics of the flexible object, and excitation force data as data concerning excitation force applied to the flexible object;
calculating, based on the oscillation response waveform model calculated, oscillation range shape data as the flexible object model data taking sectional deformation into account; and
outputting the oscillation range shape data calculated, from an output unit.

7. The computer-implemented design supporting method according to claim 6, further comprising verifying physical interference with other component data based on the oscillation range shape data calculated.

8. An electronic device designed by a computer-implemented design supporting method, the computer-implemented design supporting method comprising:
calculating an oscillation response waveform model based on flexible object model data as data concerning a flexible object fixed at least at two points, oscillation characteristic data as data concerning oscillation characteristics of the flexible object, and excitation force data as data concerning excitation force applied to the flexible object;
calculating, based on the oscillation response waveform model calculated, oscillation range shape data as the flexible object model data taking sectional deformation into account; and
outputting the oscillation range shape data calculated, from an output unit.

9. A computer program product having a computer readable medium including programmed instructions for supporting a design, wherein the instructions, when executed by a computer, cause the computer to perform:
calculating an oscillation response waveform model based on flexible object model data as data concerning a flexible object fixed at least at two points, oscillation characteristic data as data concerning oscillation characteristics of the flexible object, and excitation force data as data concerning excitation force applied to the flexible object;
calculating, based on the oscillation response waveform model calculated, oscillation range shape data as the flexible object model data taking sectional deformation into account; and
outputting the oscillation range shape data calculated, from an output unit.

10. The computer program product according to claim 9, wherein the instructions further cause the computer to perform verifying physical interference with other component data based on the oscillation range shape data calculated.
